(19) United States
(12) Patent Application Publication
(10) Pub. No.: US 2005/0212677 A1
(43) Pub. Date: Sep. 29, 2005

(54) Method and apparatus for providing information regarding an emergency

(76) Inventors: James T. Byrne, Spotsylvania, VA (US); David E. Kimmel, Fredericksburg, VA (US); Thomas E. McMullen, Canandaigua, NY (US); Ronald Dubois, Dumfries, VA (US); Donald R. Jones, New Canton, VA (US)

Correspondence Address: COVINGTON & BURLING;ATTN: PATENT DOCKETING, 1201 PENNSYLVANIA AVENUE, N.W., WASHINGTON, DC, 20004-2401, US

(21) Appl. No.: 11/053,869

(22) Filed: Feb. 10, 2005

Related U.S. Application Data
(60) Provisional application No. 60/543,923, filed on Feb. 13, 2004.

(51) Int. Cl. G08B 13/00

(52) U.S. Cl. 340/574; 340/286.06

(57) ABSTRACT

With the present invention for conveying information regarding an emergency, an alarm system can be notified of number, condition, location, and/or need of assistance of occupants within a building during an emergency. Building occupants can be informed of safe paths along which to proceed during an emergency. Further, a command workstation, such as a fire command workstation, can be integrated into an alarm system having multiple functions, detection devices, and voice communication capabilities.

This application claims priority under 35 U.S.C. §119(e) to U.S. Provisional Application No. 60/543,923, filed Feb. 13, 2004, the entirety of which is hereby incorporated by reference herein.

### BACKGROUND OF THE INVENTION

1. Field of the Invention

The present invention relates generally to conveying information regarding an emergency. More specifically, the present invention relates to conveying, to an alarm system, information such as the location of occupants within a building during an emergency. The present invention also relates to notifying building occupants where to proceed safely in a building during an emergency. The present invention further relates to integrating a command work station.

2. Related Art

Current national and local safety codes require public buildings to provide fire alarm systems to help ensure the safety of building occupants. Emergency communications systems are also required for many buildings in order to enable voice communications between a fire ground commander and various emergency responders within such buildings. Additionally, recent changes in safety codes recommend that “areas of refuge” be constructed in public buildings. These areas of refuge are constructed with slow bum materials to provide safe harbor for occupants who are trapped or who cannot safely exit the buildings without assistance.

Although these measures have affected building safety positively, time delays continue to be a challenge for first responders to emergencies. Once a group of trapped occupants is located, first responders often lack multiple portable oxygen canisters and other life-saving devices and must enter a building repeatedly to complete evacuation of the building. Delays created by lack of information, such as the number of trapped occupants, often allows emergencies, such as fires, to spread too rapidly to save all lives.

Thus, a need exists for a life safety station that would provide (1) real-time information about occupants remaining in a building, (2) the number of occupants who are trapped or in need of assistance, and (3) the location of occupants who are trapped or in need of assistance. It would also be desirable for the life safety station to provide for audio and video communication that would allow first responders to validate the status of occupants remaining in rooms of relative safety, known in the art as areas of refuge. Such capabilities would enable first responders both to direct rescue personnel to exact locations of occupants requiring assistance and to prepare sufficient supporting devices.

A method and apparatus for remotely monitoring a site is disclosed in U.S. Pat. No. 6,281,790, which is hereby incorporated by reference herein. Generally speaking, the '790 patent discloses systems and methods for remotely monitoring sites to provide real-time information that can readily permit false alarms to be distinguished, and which can identify and track the precise location of an alarm. However, a need still exists for a method and apparatus that serves to educate first responders about the number, location, and condition of occupants in a building in an emergency situation.

National and local safety codes also require the posting of “exit signs” in public buildings, directing the occupants to a safe path of egress during an emergency, such as a fire. These exit signs are static display devices that are continuously illuminated even during power outage. Such exit signs have demonstrated an ability to save lives of building occupants by providing the occupants with better knowledge of how to seek safety.

Although exit signs can positively contribute to safety, their effectiveness is limited by at least two factors: lack of awareness of sign failure on the part of persons having an interest in knowing of such failure, and inability to discourage use of exit paths that have become blocked or that pose a threat to exiting occupants.

A need exists for enhanced exit signs (“smart” exit signs) that enable an authorized official, such as a fire ground commander, to notify building occupants of the blockage of a marked exit path as well as where to find the least dangerous path to safety. These enhanced exit signs would significantly save both time and lives. A need also exists for an additional feature that reports the operational status of a smart exit sign. This feature would provide real-time knowledge of equipment failure and would contribute to proper maintenance, helping to ensure that the smart exit signs are in operation at critical moments.

Recently enacted national and local safety codes also require public buildings that have more than a certain number of floors to provide to a first responder to a building emergency the capability of intra-building voice evacuation so that the first responder can help effect an orderly evacuation of the occupants of the building.

Although current voice evacuation systems have been instrumental in safe and orderly evacuations, many first responders still operate without a comprehensive understanding of emergency events in progress. Additional lives could be saved if the first responder were to know of changing developments, such as a fire, and could deliver voice directions relative to the developments. Currently, these two functions are enabled through separate platforms, but a more comprehensive command workstation is necessary to improve life safety systems in residence and office buildings.

### SUMMARY OF INVENTION

Embodiments of the present invention generally provide a method and apparatus for alerting first responders to, among other things, (1) the fact that building occupants are trapped or in need of assistance, (2) the location of the occupants who are trapped or in need of assistance, and (3) the number of the occupants who are trapped or in need of assistance.

Other embodiments of the present invention generally provide a method and apparatus for notifying building occupants where to proceed safely in a building during an emergency, and a method for alerting building occupants of safe paths and blocked paths in a building. Embodiments may also generally provide a method for determining operational status of the invention.

Still other embodiments of the present invention relate generally to a method and apparatus for integrating a command work station and provide a method for integrating several different types of detection devices, such as smoke detectors, manual fire alarm stations, and sprinkler waterflow switches, into a single system that includes a means to automatically display the status of these devices. Such integration provides a ground commander, for example, access to changing status of a relevant facility as well as control tools to manage the situation effectively.

Further embodiments of the present invention generally provide a method and apparatus for integrating a command work station to add visual display and command and control functions that allow a first responder to manage a response to an alarm event and any resulting evacuation process.

Yet other embodiments of the present invention provide a method and apparatus for integrating a command work station to incorporate visual alarm notification graphics, an interactive touchscreen display, and an emergency communications system, including voice communications, into a single response station.

### BRIEF DESCRIPTION OF THE DRAWINGS

FIG. 1 is a diagram of a front panel of a principal user interface of an embodiment of a method and apparatus for conveying information to an alarm system.

FIG. 2 is a diagram depicting a rear view of the front panel of FIG. 1.

FIGS. 3A and 3B depict a protective cover for the principal user interface of FIG. 1.

FIG. 4 is a block diagram of a microcontroller portion of the principal user interface of FIG. 1.

FIG. 5 is a diagram of a front/rear panel of a principal user interface of an embodiment of a method and apparatus for notifying building occupants where to proceed safely in a building during an emergency.

FIG. 6 is a diagram depicting a side view of the principal user interface of FIG. 5.

FIG. 7 is a diagram of an illuminated display area for a sign according to another embodiment of the invention.

FIG. 8 is a block diagram of an embodiment of a method and apparatus for notifying building occupants where to proceed safely in a building during an emergency.

FIG. 9 is a diagram of an embodiment of a method and apparatus for integrating a command work station.

FIG. 10 is a diagram depicting main subsystems of a command work station.

### DETAILED DESCRIPTION OF EMBODIMENTS

Reference will now be made in detail to embodiments of the present invention, examples of which are illustrated in the drawings. The figures and examples that follow are illustrative of the invention, and are not meant to limit the scope of the invention.

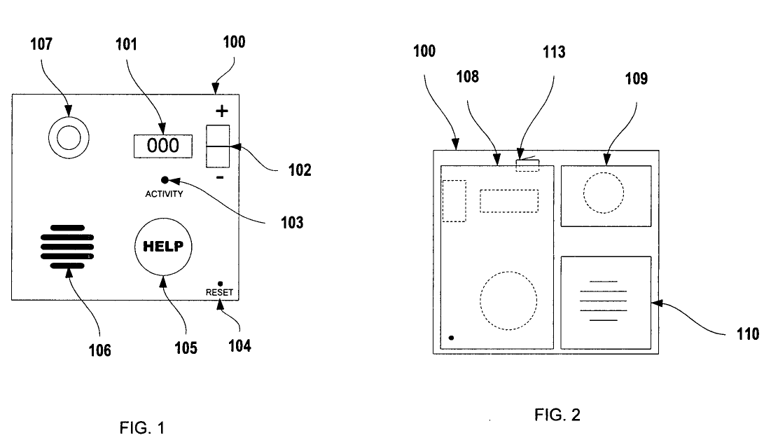

In one embodiment of the present invention of a method and apparatus for conveying information to an alarm system, a principal user interface of the invention is provided. This user interface, shown in FIG. 1, is preferably located in rooms or locations that can be occupied in a building. As shown in FIG. 1, the user interface comprises a front panel 100, a numeric display unit 101, an up/down numeric control switch 102, an activity light indicator 103, a local reset switch 104, and a duress button 105. The principal user interface is preferably in communication with an alarm system (not depicted) that can receive and, for example, display information communicated from the interface. Communication between the principal user interface and the alarm system may be provided through independent alarm closures, and may occur without user intervention upon the occurrence of a specific event, such as an error in the operation of the apparatus of FIG. 1, or may be provided by the user through a digital communications port.

In the embodiment shown in FIG. 1, the up/down numeric control switch 102 is used to manually adjust the numeric display unit 101 to reflect the number of occupants in the room in which the user interface is located. However, the present invention is not limited to manually adjusted arrangements and may use, for example, RFID technology, such as that described in U.S. Patent Application Publication No. 2003/028692 (U.S. application Ser. No. 10/140,439), which is hereby incorporated by reference herein, to signal the principal user interface of the presence of each occupant near the interface. The number displayed on the face of the numeric display unit 101 is sent to the alarm system. The activity light indicator 103 of the embodiment depicted in FIG. 1 flashes during normal operation. When there is an error in the operation of the apparatus, the activity light indicator 103 no longer flashes, but remains in either an “on” or an “off” condition.

Activating the reset switch 104 allows the panel to be locally reset, clearing any previous alarms. Depressing the duress button 105 signals an alert to the alarm system.

The embodiment shown in FIG. 1 may also include a bidirectional audio unit 106 and/or a video surveillance unit 107. Such audio and video devices are known in the art.

FIG. 2, which is a rear view of the front panel 100 of FIG. 1, depicts a microcontroller circuit board 108, video surveillance circuit board 109, and audio communications circuit board 110, which are each affixed to the panel 100. The microcontroller circuit board 108 provides all major non-audio and non-video logic functions in this embodiment of the present invention and contains its own independent clock circuitry. These logic functions comprise, for example: (1) clearance of all previously stored register values (occupant count, cover status, duress button status, activity status/timers, sound, communication buffers and flags, and numeric display); (2) commencement of a routine that causes regular blinking of the activity light indicator 103; (3) activation of user interface polling which continuously checks the status of each input (such as up count, down count, cover status, duress button status, and changes to numeric display); (4) monitoring of the current status of a cover switch 113, the up/down numeric control switch 102, the reset switch 104, and the duress button 105; and (5) signaling an alarm system of the status and monitoring information from the interface.

Also, as shown in FIG. 2, an audio communications circuit board 110 may be provided which transfers audio communications between the principal user interface located in occupied rooms and an alarm system. An example of such audio communications is a voice message that help is needed. Preferably, the alarm system includes a command workstation. A command workstation is an apparatus for integrating several different types of detection and response devices, such as smoke detectors, exit signs, security alarms, and sprinkler waterflow switches, into a single system that includes means to display and control the status of each of the devices integrated into the system. The audio communications are both initiated and concluded by a central communications unit located at the command workstation.

Also, as shown in FIG. 2, a video surveillance circuit board 109 may be provided which transfers video images of the rooms in which the user interface is located to an alarm system such as a command workstation.

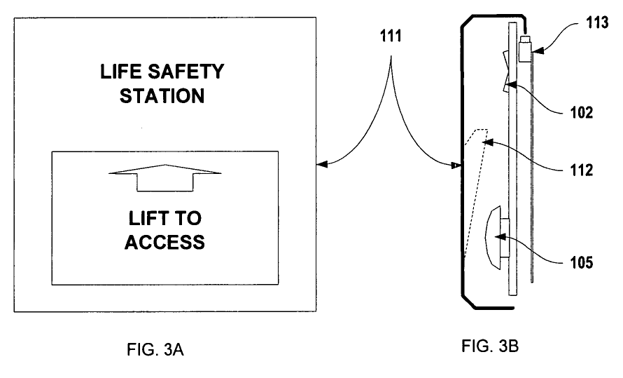

FIGS. 3A and 3B depict a protective cover 111 for the principal user interface. The protective cover 111 may be formed to include a recessed portion 112 which, for example, accommodates a person's hand such that lifting of the cover 111 is facilitated. In this embodiment of the present invention, removal of the protective cover 111 sends an alert to an alarm monitoring station (not shown). Generally speaking, when the protective cover 111 is in place, accidental contact with the principal user interface is unlikely.

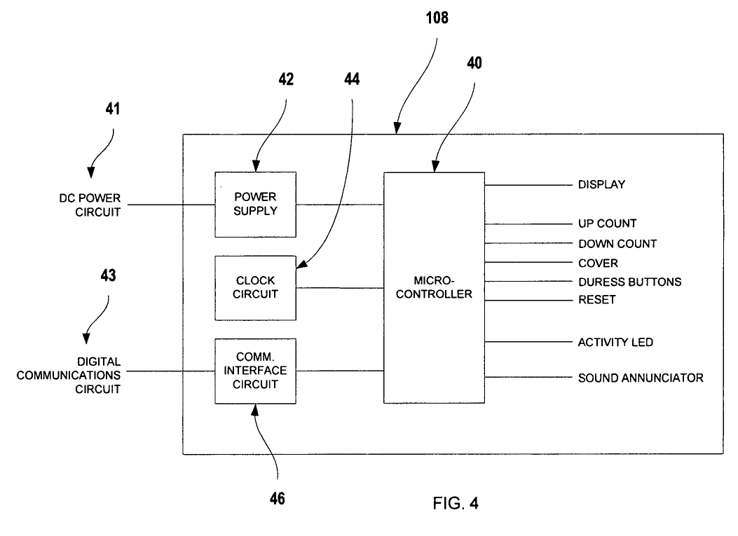

A block diagram of the microcontroller circuit board 108 is shown in FIG. 4. The microcontroller circuit board 108 includes a microcontroller 40, a power supply 42 (which is connected to a DC power circuit 41), a clock circuit 44, and a communications interface circuit 46 (which is connected to a digital communications circuit 43). Each of the power supply 42, the clock circuit 44, and the communications interface circuit 46 is connected to the microcontroller 40. As indicated above, the microcontroller circuit board 108 preforms all major non-audio and non-video logic functions of embodiments of the present invention. These functions include (1) clearance of all previously stored register values (such as occupant count, cover status, duress button status, activity status/timers, sound, communication buffers and flags, and numeric display); (2) commencement of a routine that causes regular blinking of the activity light indicator 103; (3) activation of user interface polling which continuously checks the status of each input (up count, down count, cover status, duress button status, and changes to numeric display); (4) monitoring of the current status of the cover switch 113, the up/down numeric control switch 102, the reset switch 104, and the duress button 105; and (5) signaling an alarm system of the status and monitoring information from the interface. Logic functions of audio circuits in embodiments of the present invention with audio circuit boards 110 are performed by the audio circuit board 110. Logic functions of video circuits in embodiments of the present invention with video circuit boards 109 are performed by the video circuit board 109. Generally speaking, the microcontroller 40 continually updates the status of the numeric display unit 101 based on signals from the up/down numeric control switch 102, which are in turn communicated to an alarm system over the digital communications circuit 43. Incoming data activity over the digital communications circuit 43 is indicated by flashing of the activity light indicator 103.

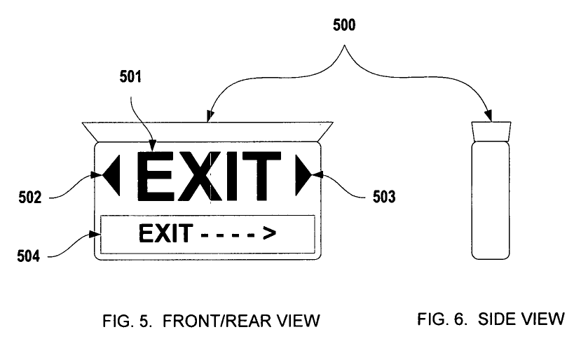

In another embodiment of the present invention, a method and apparatus for notifying building occupants where to proceed safely in a building during an emergency is provided. Such an embodiment is illustrated using FIG. 5, in which a principal user interface 500 comprises an illuminated fixed pattern display “EXIT” 501, an illuminated fixed pattern display left arrow 502, an illuminated fixed pattern display right arrow 503, and an illuminated dynamic pattern display 504. In this particular embodiment, the front and rear views of the interface 500 are substantially as shown in FIG. 5, although in other embodiments the front and rear views need not be substantially identical. For example, information may alternatively be displayed on only one side of the interface 500. FIG. 6 depicts a side view of the interface 500 depicted in FIG. 5. Although an illuminated fixed pattern display “EXIT” is shown, the present invention is not thus limited. For example, an illuminated fixed pattern display could be any word in any language, depending on the anticipated use of the invention.

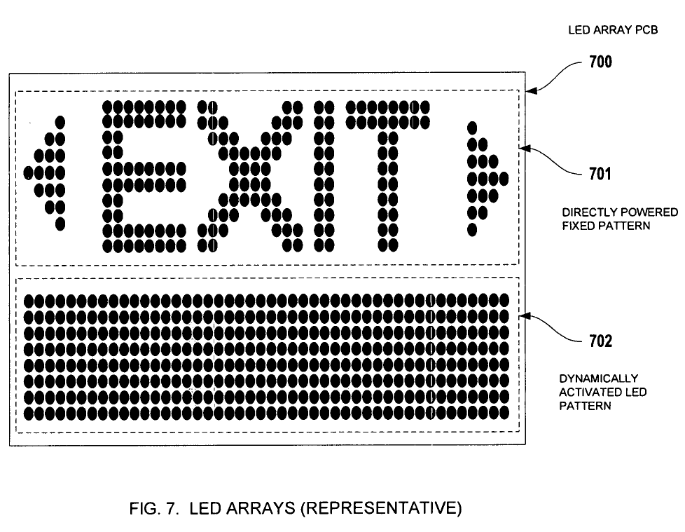

Another embodiment of the present invention is shown in FIG. 7. In this embodiment, the entire display area 700 of a sign is organized into two areas: a directly-powered fixed pattern display area 701, and a dynamically activated LED pattern area 702. A variety of messages can be selectively displayed in the area 702, depending on circumstances. For example, the area 702 can provide the message “WARNING—SMOKE” if smoke would be encountered by going in the direction of the sign.

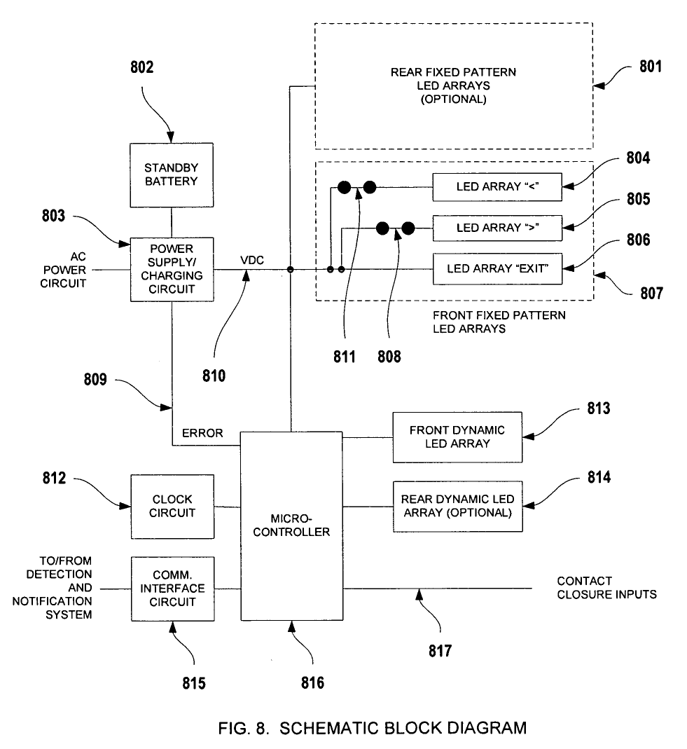

A schematic block diagram of one embodiment of the present invention is shown in FIG. 8. This block diagram illustrates the functionality of an embodiment of the present invention, such as that shown in FIG. 7. Fixed pattern displays 801 and 807 correspond to the directly-powered fixed pattern display area 701 shown in FIG. 7. These displays (display 801 corresponding to an optional rear fixed pattern display and display 807 corresponding to the front fixed pattern display) receive direct current voltage 810 from a standby battery 802, which is charged by a power supply/charging circuit 803, into which primary alternating current enters.

The fixed pattern displays 801 and 807 can be subdivided into a number of sections. In the embodiment shown in FIG. 8, the fixed pattern display 807 is subdivided in three sections: LED array 806 which reads “EXIT,” LED array 805 which is a right-pointing arrow, and LED array 804 which is a left-pointing arrow. In this embodiment, the fixed pattern directional LED arrays 804 and 805 can be disconnected from the direct current voltage sources 811 and 808, and the fixed pattern “EXIT” LED array 806 is always provided with power and cannot be disabled while the fixed pattern display 807 is in use. Thus, the “EXIT” portion is always illuminated while the fixed pattern display 807 is in use, but the directional arrows can be selectively turned on and off. For example, when the exit path is to the right of the sign, only the right-pointing arrow (805) should be provided with power, and the left-pointing arrow (804) should not be provided with power.

As shown in FIG. 8, front dynamic LED array 813 and an optional rear dynamic LED array 814 may also be provided. These dynamic arrays correspond, for example, with area 702 shown in FIG. 7.

The dynamic LED arrays 813 and 814 allow authorized personnel, such as emergency responders, to cause the display of specific messages such as “WARNING—SMOKE,” for example by sending a signal that the message should be displayed. Modification of these dynamic arrays can be instigated by an authorized emergency responder who is remote from the location where the sign is placed, using a detection and notification system, such as a command workstation as previously described, which is in communication with the sign.

The desired modification of dynamic arrays may be communicated to an embodiment of the invention in a variety of ways. For instance, one way that the desired modification may be communicated is by use of communications interface circuit 815. When an authorized emergency responder activates a message to be displayed, which may be either a previously stored message or a custom message, information regarding the activated message is communicated to the communications interface circuit 815. Microcontroller 816 manages such communications and updates the dynamic LED arrays 813 and 814 through multiple control line inputs that are used to illuminate the LED arrays and to signal to observers that the sign is operating normally. Clock circuit 812 is provided for producing timing signals that may be required by the microcontroller 816.

The desired modification of dynamic LED arrays 813 and 814 may also be controlled by contact closure inputs 817. Such contact closure inputs may also be provided by an authorized emergency responder who is remote from the location where the sign is placed. These inputs select an internally stored display, each contact representing a bit of the binary address of the stored display. As an example, the emergency responder could select address 0000, which could represent a blank display. Alternatively, the emergency responder could select address 0001, which could represent a “WARNING—SMOKE” display. The contact closure inputs 817 may be used in embodiments in which the communications interface circuit 815 is not employed.

Other techniques for modifying the dynamic LED arrays 813 and 814 are possible, as should be apparent in view of this specification to those of skill in the art.

In the embodiment shown in FIG. 8, a failure of the power supply/charging circuit 803 produces an error signal 809. The microcontroller 816 receives the error signal 809 and may signal it to an alarm system.

In alternative embodiments of the present invention, communications from a detection and notification system can be transmitted via radio or other wireless means to a sign so that the sign can still operate even if regular power and communications lines have failed.

Moreover, an embodiment of the present invention can contain an illuminated dynamic pattern display without an illuminated fixed pattern display, or, alternatively, an embodiment of the invention can contain an illuminated fixed pattern display without an illuminated dynamic pattern display.

Still another embodiment of the present invention provides a method and apparatus for integrating a command work station. In such an embodiment, a command workstation is provided so that first responders to a building emergency can be aware of ongoing alarm events and can be able to access command control functions necessary to manage the safe evacuation of occupants in the building.

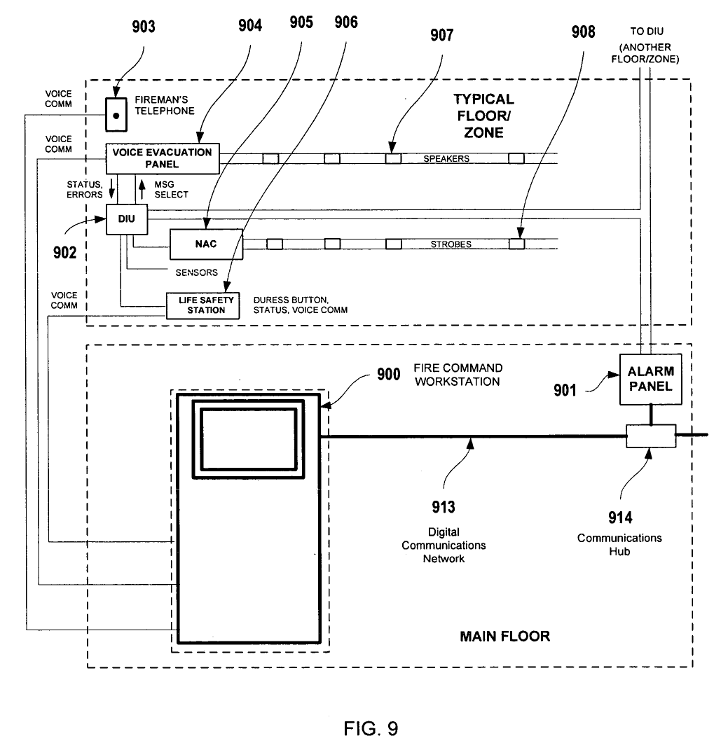

An example of an embodiment integrating a command work station is illustrated in FIG. 9. This example embodiment includes a fire command workstation 900, a building alarm panel 901, a device interface unit (DIU) 902, a fireman's telephone 903, a voice evacuation panel 904, a notification appliance circuit (NAC) 905, a life safety station 906, evacuation speakers 907, and visible strobes 908. Although a fire command workstation is shown, the invention is not limited in application to fire command workstations. For example, the present invention can have suitable applications in many emergency situations, including fires, natural disasters, terrorist attacks, and so on.

The fire command workstation 900 communicates with the building alarm panel 901 over a digital communications network 913 (which may include a communications hub 914) through a hardwire connection.

Alternatively, the fire command workstation 900 communicates with the building alarm panel 901 over the digital communications network 913 (which may include a communications hub 914) through wireless communications.

In general, the building alarm panel 901, comprises processors and other electronics that receive and transmit information and commands to various components of a building safety system (for example, life safety station 906, voice evacuation panel 904, sensors such as fire alarms, and so on). The building alarm panel 901 may also update the fire command workstation 900 based on information received from these components, such as changing alarm status throughout the building. Updating may occur on a periodic basis depending on circumstances. Alternatively, “updating” may essentially be continuous. As an example of updating, the building alarm panel 901 may be configured to receive signals from smoke detectors located throughout the building. If one of the smoke detectors is triggered by smoke in a particular room, the building alarm panel 901 receives signals indicating a change of status representing the triggering of the smoke detector. The building alarm panel 901 then updates the fire command workstation 900 accordingly.

A user of the fire command workstation 900 may instruct the alarm panel 901 to enable selected, or all, voice evacuation panels 904 to begin broadcasting a prerecorded message, which may be digital or analog, directing occupants of a building in an evacuation process. The fire command workstation 900 may be programmed to display a variety of messages, for example on a graphical touchscreen interface on the fire command workstation 900. The user selects a message from the displayed messages, and in response to the selecting, the fire command workstation 900 may then signal the alarm panel 900, which in turn provides an appropriate instruction to the voice evaluation panels 904, at which prerecorded messages may be stored. Thus, for example, on instruction, the alarm panel 901 may direct the device interface units 902 to activate the voice evacuation panels 904 and/or the notification appliance circuits 905. As should be apparent to those of skill in the art in view of this specification, the device interface unit 902 may be a device that allows an alarm panel to communicate with a number of different devices such as sensors, a life safety station, a voice evacuation panel, and the like. The voice evacuation panels 904 may then direct a message to be broadcast by the attached evacuation speakers 907. In addition, the notification appliance circuits 905 may optionally activate the attached visible strobes 908.

Alternatively, a user of the fire command workstation 900 may activate voice communications circuits between the fire command workstation 900 and the life safety stations 906. A life safety station 906 is a device located within a room of a building that contains a duress alarm and is provided with a voice communication capability and a capability for tracking the number of occupants in the room. The voice communication circuits allow the user of the fire command workstation 900 to engage in voice communication with a person located at the life safety station 906. The voice communication circuits may be any of a number of systems allowing for transmission of voice signals, such as systems having hardwire, wireless, or other connections that should be apparent to one skilled in the art in light of this specification. Among other reasons, the voice communications circuits between the fire command workstation 900 and the life safety station 906 might be activated to validate a duress alarm sent by the life safety station 906 and/or to provide instruction to occupants trapped in a building.

As another alternative, a user of the fire command workstation 900 may activate voice communications circuits between the fire command workstation 900 and the voice evacuation panels 904. The voice communication circuits in this alternative may also be any of a number of systems allowing for transmission of voice signals, such as systems having hardwire, wireless, or other connections that should be apparent to one skilled in the art in view of this specification. This alternative allows the user of the fire command workstation 900 to broadcast a live message over the voice evacuation panels 904 rather than the prerecorded messages described above, or to temporarily mute prerecorded messages while a live message is being broadcast.

In a further alternative, a user may activate voice communications circuits between the fire command workstation 900 and the fireman's telephones 903. Once again, the voice communication circuits may be any of a number of systems allowing for transmission of voice signals, such as systems having hardwire, wireless, or other connections that should be apparent to one skilled in the art in view of this specification. One reason to activate the voice communications circuits between the fire command workstation 900 and single or multiple fireman's telephones 903 might be to coordinate response activity with other responders.

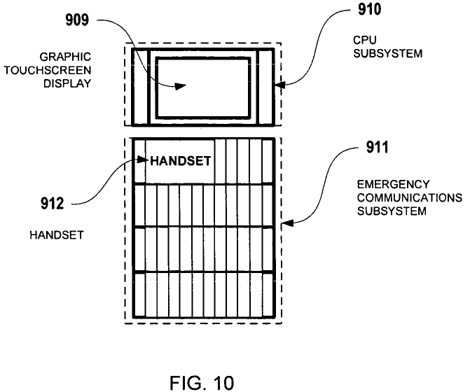

Subsystems of the fire command workstation 900 of FIG. 9 are shown in FIG. 10. As depicted in FIG. 10, these subsystems comprise a graphic touchscreen display 909, a CPU subsystem 910, an emergency communications subsystem 911, and a handset 912. The graphic touchscreen display 909 is the primary interface between the fire command workstation 900 and the user. All or some portion of ongoing alarm activity may be visually displayed to the user through changing images shown on the graphic touchscreen display 909. Thus, for example, if smoke is detected in a particular section or room of a building being monitored, a symbol representing smoke may appear on the graphic touchscreen display 909, along with a message indicating where the smoke is located. The graphic touchscreen display 909 may contain a graphic representation of the building, and a symbol representing smoke may appear on a portion of the graphic representation representing the room in which the smoke has been detected. The user may use the touchscreen interface to navigate through display screens and to engage voice evacuation functions on demand. For example, a number of display screens representing various floors of a multi-floor building may be provided. The user may navigate through the number of display screens to monitor activity throughout the building. Thus, for example, if occupants are trapped in a conference room on the third floor of a building, the user of the fire command workstation 900 may navigate through various screens to get to a representation of the conference room on the third floor. The user may then activate, for example, a voice evacuation panel 904 located in the conference room to provide information to the trapped occupants about how to exit the building.

The voice communications system 911 conveys voice communications between the user of the fire command workstation 900 and the various components that are connected to the fire command workstation 900 via voice communications circuits. The various components may include, for example, the life safety station 906, the voice evacuation panel 904, and the fireman's telephone 903. The handset 912 enables voice input from the user of the fire command workstation 900 to the emergency voice communications subsystem 911.

The emergency voice communication system 911 may utilize analog technology to provide voice communications to the life safety station 906, the voice evacuation panel 904, and the fireman's telephones 903.

Alternatively, the emergency voice communication system 911 may utilize digital technology to provide voice communications to the life safety station 906, the voice evacuation panel 904, and the fireman's telephones 903.

It will be appreciated by those skilled in the art that the present invention can be embodied in various ways within the spirit of the invention. The scope of the invention is not to be limited by the illustrative examples given above, but rather is to be defined by the appended claims.

1. An apparatus comprising:
a microcontroller;
a numerical display unit and a numerical input device, wherein the microcontroller is in communication with the numerical display unit, and wherein the numerical display unit is in communication with the numerical input device;
a duress button in communication with the microcontroller; and
a protective cover switch in communication with the microcontroller.

2. The apparatus of claim 1, further comprising a bidirectional audio unit configured to communicate with an alarm system.

3. The apparatus of claim 1, further comprising a video surveillance unit configured to transfer a video image to an alarm system.

4. A method for conveying information, the method comprising:
in response to opening of a protective cover of a user interface, signalling an alarm system that the protective cover has been opened;
receiving information related to occupants in a vicinity of the user interface; and
transmitting the received information to the alarm system.

5. The method of claim 4, wherein the received information comprises the number of the occupants in the vicinity of the user interface.

6. The method of claim 4, wherein the received information comprises a condition of the occupants in the vicinity of the user interface.

7. An apparatus for indicating a safe path in a building, the apparatus comprising:
a first fixed pattern display;
a second fixed pattern display of a first directional indicator;
a third fixed pattern display of a second directional indicator;
a dynamic pattern display; and
a data communications port connected to a microprocessor that controls the dynamic pattern display, wherein the data communications port is configured to send and receive information regarding the dynamic pattern display.

8. The apparatus of claim 7, wherein the first fixed pattern display is a display of at least one word.

9. A method for indicating a safe path in a building, the method comprising:
providing a sign comprising a first fixed pattern display, a second fixed pattern display of a first directional indicator, a third fixed pattern display of a second directional indicator, and a dynamic pattern display; and
illuminating one of the second fixed pattern display and the third fixed pattern display, thereby indicating the safe path.

10. The method of claim 9, wherein the first fixed pattern display is a display of at least one word.

11. A monitoring system comprising:
a command workstation comprising a graphic display; and
a plurality of monitoring devices, the plurality of monitoring devices including at least one monitoring device capable of voice communication with the command workstation,
wherein the command workstation is coupled to the plurality of monitoring devices, and the graphic display is configured to provide a graphical representation of information provided by the plurality of monitoring devices.

12. The monitoring system of claim 11, wherein the plurality of monitoring devices comprises at least one of:
a building alarm panel;
a device interface unit;
a fireman's telephone;
a voice evacuation panel;
a notification appliance circuit; and
a visible strobe.

13. The monitoring system of claim 11, wherein the graphic display comprises an interactive touchscreen display.

14. An event command workstation comprising:
a graphic display configured to provide a graphical representation of information sent to the event command workstation by each of a plurality of monitoring devices; and
a communications unit that provides voice communication with at least one of the plurality of monitoring devices.

15. The event command workstation of claim 14, wherein the graphic display is configured to provide a graphical representation of information provided by a life safety station, and the communications unit provides voice communication with the life safety station.

16. The event command workstation of claim 14, wherein the graphic display is configured to provide a graphical representation of information provided by at least one voice evacuation panel, and the communications unit provides voice communication with the at least one voice evacuation panel.

17. The event command workstation of claim 14, wherein the graphic display is configured to provide a graphical representation of information provided by at least one fireman's telephone, and the communications unit provides voice communication with the at least one fireman's telephone.
